(19) United States
(12) Patent Application Publication
(10) Pub. No.: US 2024/0367890 A1
(43) Pub. Date: Nov. 7, 2024

(54) STORAGE CONTAINER FOR PRODUCE

(71) Applicant: Autostore Technology AS, Nedre Vats (NO)

(72) Inventor: Paola Mariana Saravia-Ugarte, Skjold (NO)

(73) Assignee: Autostore Technology AS, Nedre Vats (NO)

(21) Appl. No.: 18/689,735

(22) PCT Filed: Sep. 7, 2022
(86) PCT No.: PCT/EP2022/074786

§ 371 Date: Mar. 6, 2024

(30) Foreign Application Priority Data
Sep. 7, 2021 (NO) 20211071

(51) Int. Cl. B65D 85/34; B65D 43/16; B65D 53/02; B65D 81/26; B65G 1/04

(52) U.S. Cl. CPC B65D 85/345; B65D 43/163; B65D 53/02; B65D 81/263; B65G 1/0464; B65D 2205/02; B65D 2543/00194

(57) ABSTRACT

A storage container stores produce in an automated storage and retrieval system. The storage container includes a base panel; four side panels extending from the base; and a top panel provided above the four side panels. The base panel, the four side panels, and the top panel define a storage compartment. The storage container includes an adjustable ventilation opening provided in the base panel, the top panel, or one of the four side panels.

### FIELD OF THE INVENTION

The present invention relates to a storage container for storing produce in an automated storage and retrieval system. The present invention also relates to a method for storing produce in an automated storage and retrieval system. The present invention also relates to an automated storage and retrieval system.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a, 301a, 401a and first and second sets of wheels 201b, 201c, 301b, 301c, 401b, 401c which enable the lateral movement of the container handling vehicles 201,301,401 in the X direction and in the Y direction, respectively. In FIGS. 2, 3 and 4 two wheels in each set are fully visible. The first set of wheels 201b, 301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b, 401c can be lifted and lowered, so that the first set of wheels 201b,301b,401b and/or the second set of wheels 201c, 301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=7 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=5. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a, 401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119, 120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

In FIG. 5, a prior art storage container 106 is shown to comprise a rectangular base 106a and four side panels 106b extending from the base 106a. The storage container 106a has an access opening 106AO, indicated as a dashed line, through which product items 80 can be inserted into and retrieved from the storage container 106. The storage container 106 further comprises a connection interface CI used by the container handling vehicles 40 201, 301, 401 to lift the storage container 106. On the interior side of the side panels 106b, recesses 106r are formed. These recesses 106r are used to insert separation walls (not shown) into the storage container, to separate a main storage compartment 106S into two or more subcompartments.

WO 2021/037488 describes spacers for stacking between storage containers to allow fluid (typically air or other gases with predetermined properties (temperature/humidity etc.) to circulate through the stacks of storage containers. It also describes different types of storage containers with ventilation openings to allow the fluid to enter/exit the storage containers.

One object of the present invention is to provide a storage container for storing produce. The term produce refers to products of agriculture, such as fruits, vegetables, sprouts, mushrooms, nuts, herbs etc.

### SUMMARY OF THE INVENTION

The present invention relates to a storage container for storing produce in an automated storage and retrieval system, wherein the storage container comprises:
a base panel;
four side panels extending from the base;
a top panel provided above the four side panels;
   wherein the base panel, the four side panels and the top panel define a storage compartment;
   wherein the storage container comprises an adjustable ventilation opening provided in the base panel, the top panel or one of the four side panels.

Some types of produce have a longer durability with no or little ventilation. In this case, the adjustable ventilation opening may be closed or near closed. Other types of produce have a longer durability with more ventilation. In this case the adjustable ventilation opening may be fully open or near fully open. The term “ventilation” here refers to the amount of air or gases (typically oxygen, carbon dioxide, nitrogen, ethylene) the produce is exposed to. Hence, the term “ventilation” does here not refer to controlling the temperature of the produce.

Hence, the adjustable ventilation opening may be referred to as an adjustable air vent.

In one aspect, the base panel, the four side panels and the top panel defines an air-tight storage compartment when the adjustable ventilation opening is closed off.

In one aspect, the storage container comprises an access opening for inserting produce into the storage compartment or for retrieving produce out from the storage compartment; wherein at least a section of the top panel or at least a section of one of the four side panels forms a closure of the access opening.

Alternatively, the adjustable ventilation opening is also the access opening.

In one aspect, the entire top panel forms a closure of the access opening.

In one aspect, the top panel is liftable up from the access opening and is insertable into the access opening.

In one aspect, the top panel is a panel separate from the side panels, allowing the top panel to be lifted from the access opening. The top panel may here be lifted vertically up from the access opening to open the access opening and the top panel may be inserted into the access opening to close the access opening. Alternatively, the top panel may be movably connected to one or more of the panels. The top panel may be hinged to one of, or hinged between two of, the side panels. Alternatively, the top panel may be slidably connected between two of the side panels.

In one aspect, the top panel may comprise a user interface which makes it easier to open the access opening. The user interface may be a handle etc. used by a human operator. The user interface may also be a user interface for use by a machine, i.e. the access opening is opened and closed by means of a machine moving the top panel relative to the access opening.

In one aspect, the top panel is sealingly engaged with the side panels.

In one aspect, the storage container comprises a sealing element, wherein the top panel is sealingly engaged with the side panels by means of the sealing element.

In one aspect, the storage container comprises a sealing element for sealingly engaging the top panel with the side panels.

In one aspect, the storage container comprises:
recesses formed on the interior side of the side panels; and
a top panel support inserted into the recesses for supporting the top panel when engaged with the side panels.

In one aspect, the adjustable ventilation opening is integrated in the top panel.

In this way, by using a top panel support inserted into the recesses and by closing the access opening by means of the top panel in which the adjustable ventilation opening is integrated, the prior art storage containers can be modified for storing produce in a simple and efficient way.

In one aspect, the adjustable ventilation opening is a linear slider. In one aspect, the adjustable ventilation opening is a rotational vent.

In one aspect, the storage container comprises a lower stacking interface and an upper stacking interface; thereby allowing the storage container to be stacked above or below similar or identical storage containers.

In one aspect, the storage container comprises an upper vehicle connection interface, thereby allowing the storage container to be lifted via the upper vehicle connection interface.

The present invention also relates to a method for storing produce in an automated storage and retrieval system, wherein the method comprises the steps of:
inserting produce into a storage compartment of a storage container;
adjusting an adjustable ventilation opening of the storage container according to the type of produce inserted into the storage compartment.

In one aspect, the storage container is a storage container according to any one of the above claims.

In one aspect, the method further comprises the following steps after the step of inserting produce into the storage compartment:
sealing an access opening of the storage container by means of at least a section of the top panel or at least a section of one of the four side panels.

In one aspect, the method further comprises the following steps:
selecting a storage position in the automated storage and retrieval system based on the type of produce inserted into the storage compartment.

The present invention also relates to an automated storage and retrieval system comprising a framework structure, wherein the framework structure comprises:
upright members;
a storage volume comprising storage columns provided between the upright members;
a rail system provided on top of the upright members;
   wherein the automated storage and retrieval system comprises:
container handling vehicles moving on the rail system;
storage containers according to any one of the above claims, wherein the storage containers are stackable in stacks within the storage columns by means of the container handling vehicles.

In one aspect, the storage container comprises a lower stacking interface and an upper stacking interface; thereby allowing the storage container to be stacked above or below similar or identical storage containers.

In one aspect, the storage container comprises an upper vehicle connection interface, thereby allowing the storage container to be lifted by the container handling vehicles.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a perspective view of a prior art storage container.

FIG. 6a is a perspective view of a first embodiment of the storage container.

FIG. 6b is a cross sectional side view of the first embodiment of the storage container.

FIG. 7a is a side view of a second embodiment of the storage container in its closed state.

FIG. 7b is a side view of the second embodiment of the storage container in its open state.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

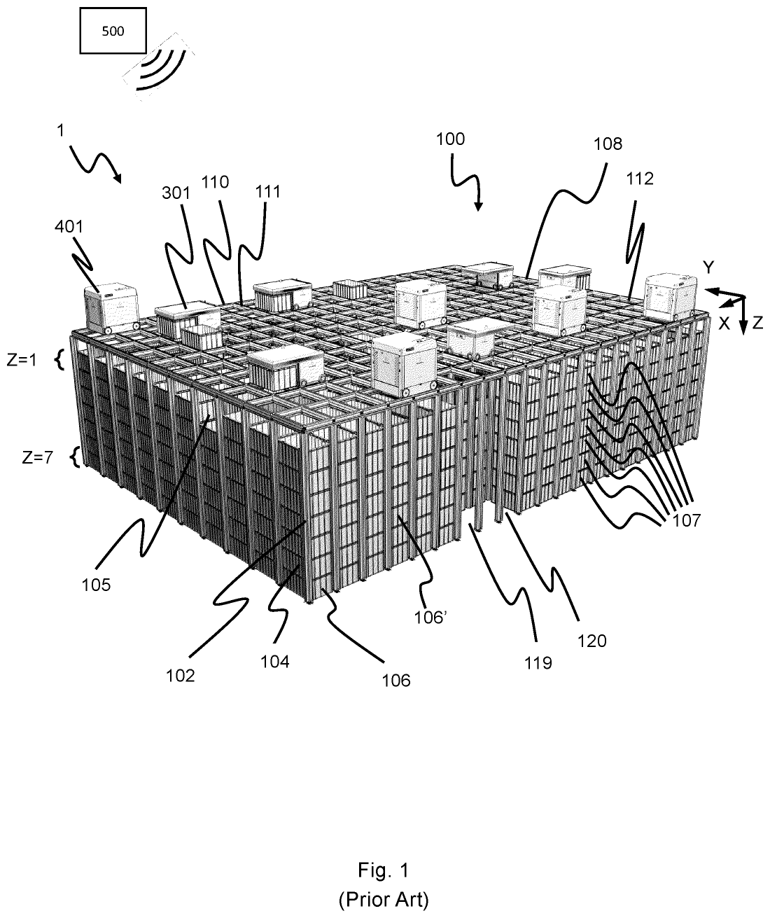

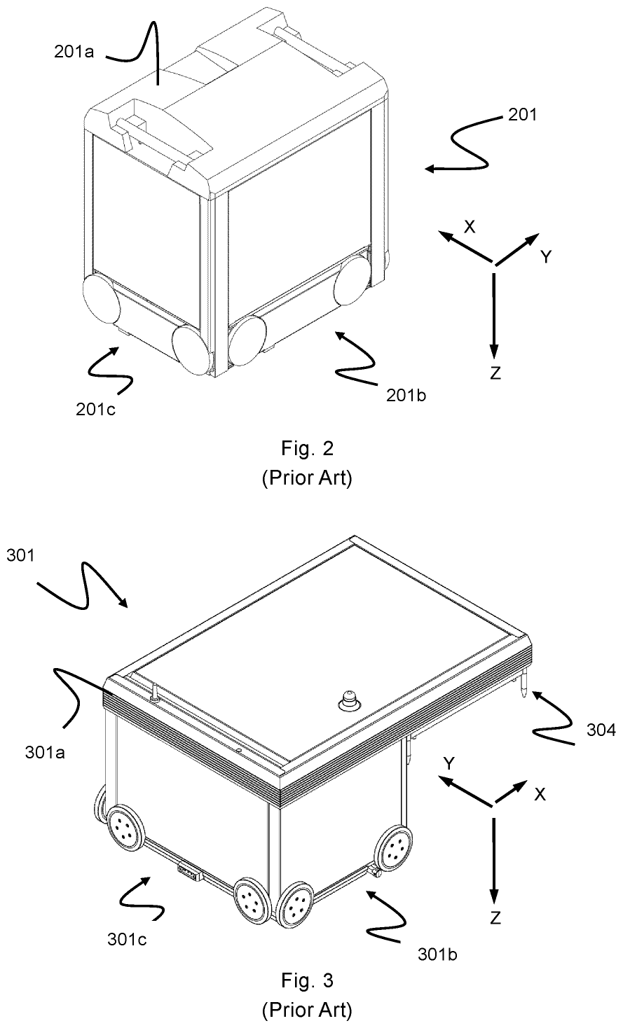

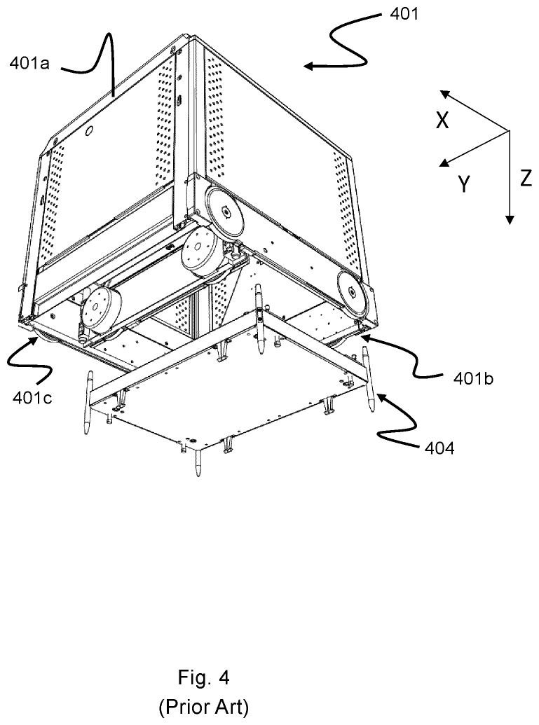

The framework structure 100 of the automated storage and retrieval system 1 is constructed in a similar manner to the prior art framework structure 100 described above in connection with FIGS. 1-3. That is, the framework structure 100 comprises a number of upright members 102, and comprises a first, upper rail system 108 extending in the X direction and Y direction.

The framework structure 100 further comprises storage compartments in the form of storage columns 105 provided between the members 102 wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

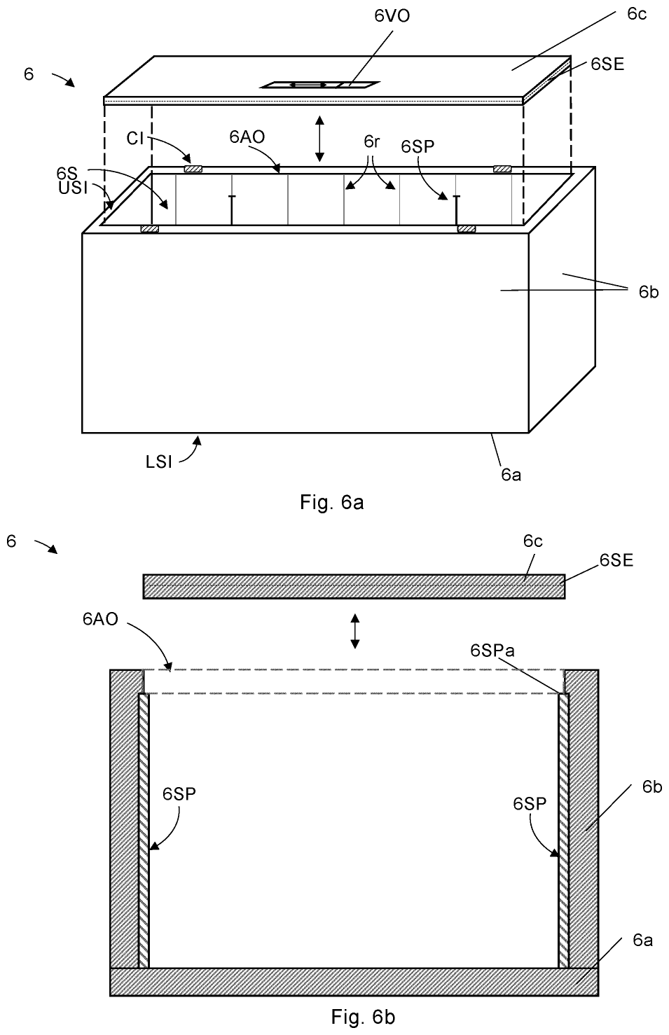

One embodiment of the automated storage and retrieval system according to the invention will now be discussed in more detail with reference to FIG. 6a and FIG. 6b.

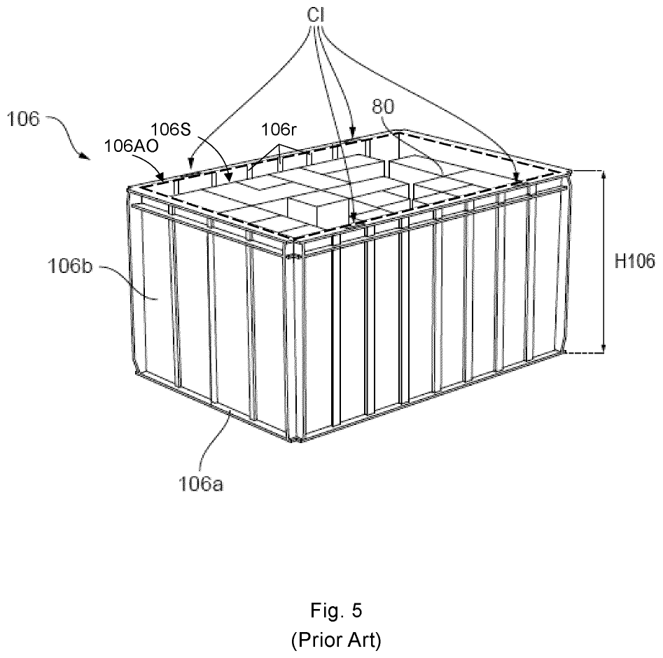

Here it is shown a storage container 6 comprising a base panel 6a with four side panels 6b extending from the base 6a. The storage container 6 is here of the prior art type of storage container 106, shown in FIG. 5. Hence, the storage container comprises a lower stacking interface LSI and an upper stacking interface USI; thereby allowing the storage container to be stacked above or below similar or identical storage containers. The storage container further comprises an upper vehicle connection interface CI, thereby allowing the storage container to be lifted via the upper vehicle connection interface.

In addition, the storage container 6 comprises a top panel 6c.

The storage container 6 comprises an access opening 6AO for inserting produce into the storage compartment 6S or for retrieving produce out from the storage compartment 6S. In the present embodiment, the top panel 6c is at least partially insertable into the access opening 6AO and is hence forming a closure of the access opening 6AO. The base panel 6a, the four side panels 6b and the top panel 6c define a storage compartment 6S.

The side panels 6b comprises recesses 6r formed on the interior side of the side panels 6b. Into at least some of these recesses 6r, a top panel support 6SP is inserted. An upper end 6SPa of the top panel support 6SP forms a platform for the top panel 6c and hence limits how far into the access opening 6AO the top panel 6c can be inserted. The dashed box in FIG. 6b indicates the position for the top panel 6c when engaging the upper end 6SPa of the top panel support 6SP.

Alternatively, the top panel 6c may comprise a support projecting horizontally out from the top panel 6c, which is engaging the upper surface of one or more of the side panels. This will also limit how far into the access opening 6AO the top panel 6c can be inserted.

The storage container 6 further comprises a sealing element 6SE for sealingly engaging the top panel 6c with the side panels 6b. In the present embodiment, the sealing element 6SE is provided circumferentially outside the top panel 6c and will hence prevent air flow between the top panel 6c and the side panels 6b when inserted into the access opening 6AO. Consequently, an air-tight storage compartment 6S is achieved in the compartment defined within the base panel 6a, the four side panels 6b and the top panel 6c.

The storage container 6 further comprises an adjustable ventilation opening 6VO provided in the top panel 6c. In the present embodiment, the adjustable ventilation opening 6VO comprises a slider which can be moved between an open and a closed position, wherein the cross sectional area of the opening gradually increases when moving the slider from the closed position to the open position. In the closed position, the compartment 6S is considered to be an airtight compartment.

Some types of produce have a longer durability with no or little ventilation. In this case, the adjustable ventilation opening 6VO may be closed or near closed. Other types of produce have a longer durability with more ventilation. In this case the adjustable ventilation opening 6VO may be fully open or near fully open. Hence, optimal ventilation may be provided for different type of produce.

The above storage containers may be used in the following way. As an example, an empty storage container is moved by one of the container handling vehicles from one of the storage columns 105 of the framework structure to a port. Here, produce is inserted into the storage compartment 6S of the storage container 6 and the top panel 6c is inserted into the access opening 6AO to close the storage container. Then, the adjustable ventilation opening 6VO of the storage container 6 is adjusted according to the type of produce inserted into the storage compartment.

Then the storage container 6 is moved back to one of the storage columns within the framework structure 100. Here, the control system 500 of the automated storage and retrieval system 1 may be configured to select the new storage position for the storage container based on the type of produce inserted into the storage compartment 6S.

As an example, ethylene-producing fruits such as apples, bananas etc. should be stored at a distance from ethylene-sensitive fruits/vegetables such as avocados, lemons, onions etc. In this way, durability for the produce is further increased.

### Alternative Embodiments

In one alternative embodiment, the adjustable ventilation opening is also the access opening 6AO. This may be achieved by integrating the top panel 6c with the side panels 6b (i.e. the top panel 6c may not be removed from the side panels) and provide a larger slider as the adjustable ventilation opening. When fully open, the opening in the adjustable ventilation opening is also used as the access opening 6AO.

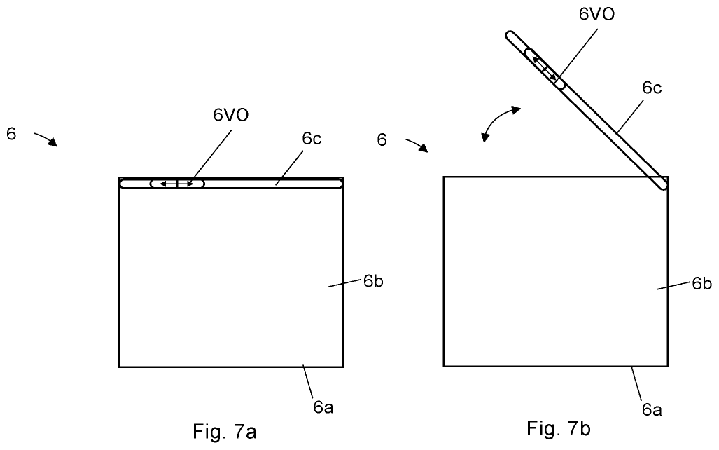

In one alternative embodiment shown in FIG. 7a and FIG. 7b, the top panel 6c is movably connected to one or more of the panels by means of a hinged type of connection or another type of connection.

In the preceding description, various aspects of the storage container according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 prior art automated storage and retrieval system
6 storage container
6a base
6ao access opening
6b side panels
6b side panels
6c top panel
6r recesses
6s compartment
6se sealing element
6sp top panel support
6spa upper end
6vo adjustable ventilation opening
100 framework structure
102 upright members of framework structure
104 storage grid
105 storage column
106 storage container
106′ particular position of storage container
107 stack
108 rail system
110 parallel rails in first direction (x)
112 access opening
119 first port column
120 second port column
201 prior art container handling vehicle
201a vehicle body of the container handling vehicle 201
201b drive means/wheel arrangement/first set of wheels in first direction (x)
201c drive means/wheel arrangement/second set of wheels in second direction (y)
301 prior art cantilever container handling vehicle
301a vehicle body of the container handling vehicle 301
301b drive means/first set of wheels in first direction (x)
301c drive means/second set of wheels in second direction (y)
401 prior art container handling vehicle
401a vehicle body of the container handling vehicle 401
401b drive means/first set of wheels in first direction (x)
401c drive means/second set of wheels in second direction (y)
500 control system
X first direction
y second direction
z third direction

1. A storage container for storing produce in an automated storage and retrieval system, wherein the storage container comprises:
a base panel;
four side panels extending from the base;
a top panel provided above the four side panels;
wherein the base panel, the four side panels and the top panel define a storage compartment;
wherein the storage container comprises an adjustable ventilation opening provided in the base panel, the top panel or one of the four side panels.

2. The storage container according to claim 1, wherein the base panel, the four side panels and the top panel defines an air-tight storage compartment when the adjustable ventilation opening is closed off.

3. The storage container according to claim 1, wherein the storage container comprises an access opening for inserting produce into the storage compartment or for retrieving produce out from the storage compartment; wherein at least a section of the top panel or at least a section of one of the four side panels forms a closure of the access opening.

4. The storage container according to claim 3, wherein the entire top panel forms a closure of the access opening.

5. The storage container according to claim 4, wherein the top panel is liftable up from the access opening and is insertable into the access opening.

6. The storage container according to claim 4, wherein the top panel is sealingly engaged with the side panels.

7. The storage container according to claim 1, wherein the storage container comprises a sealing element, wherein the top panel is sealingly engaged with the side panels by means of the sealing element.

8. The storage container according to claim 5, wherein the storage container comprises:
recesses formed on the interior side of the side panels; and
a top panel support inserted into the recesses for supporting the top panel when engaged with the side panels.

9. The storage container according to claim 1, wherein the adjustable ventilation opening is integrated in the top panel.

10. The method for storing produce in an automated storage and retrieval system, wherein the method comprises:
inserting produce into a storage compartment of a storage container;
adjusting an adjustable ventilation opening of the storage container according to the type of produce inserted into the storage compartment.

11. The method according to claim 10, wherein the method further comprises, after the step of inserting produce into the storage compartment:
sealing an access opening of the storage container by means of at least a section of the top panel or at least a section of one of the four side panels.

12. The method according to claim 10, wherein the method further comprises:
selecting a storage position in the automated storage and retrieval system based on the type of produce inserted into the storage compartment.

13. An automated storage and retrieval system comprising a framework structure, wherein the framework structure comprises:
upright members;
a storage volume comprising storage columns provided between the upright members;
a rail system provided on top of the upright members;
wherein the automated storage and retrieval system comprises:
container handling vehicles moving on the rail system;
storage containers according to for storing produce in an automated storage and retrieval system, wherein each storage container comprises:
a base panel;
four side panels extending from the base;
a top panel (6c) provided above the four side panels;
wherein the base panel, the four side panels and the top panel define a storage compartment;
wherein the storage container comprises an adjustable ventilation opening provided in the base panel, the top panel or one of the four side panels,
wherein the storage containers are stackable in stacks within the storage columns by means of the container handling vehicles.

14. The automated storage and retrieval system according to claim 13, wherein the storage container comprises a lower stacking interface and an upper stacking interface; thereby allowing the storage container to be stacked above or below similar or identical storage containers.

15. The automated storage and retrieval system according to claim 13, wherein the storage container comprises an upper vehicle connection interface, thereby allowing the storage container to be lifted by the container handling vehicles.
